(19) United States
(12) Patent Application Publication
(10) Pub. No.: US 2023/0219754 A1
(43) Pub. Date: Jul. 13, 2023

(54) DEVICE FOR SECURING A SHUTTLE, SHUTTLE AND SHELF SYSTEM

(71) Applicant: Rocket Solution GmbH, Unterhaching (DE)

(72) Inventor: Florian VENT, Riemerling (DE)

(73) Assignee: Rocket Solution GmbH, Unterhaching (DE)

(21) Appl. No.: 18/114,618

(22) Filed: Feb. 27, 2023

Related U.S. Application Data
(63) Continuation of application No. PCT/EP2021/073305, filed on Aug. 23, 2021.

(30) Foreign Application Priority Data
Aug. 27, 2020 (DE) 10 2020 122 390.0

(51) Int. Cl. B65G 1/04

(52) U.S. Cl. CPC B65G 1/0492; B65G 2207/28; B65G 2207/40

(57) ABSTRACT

A device for a shelf system for load carriers for securing a shuttle before leaving its running rail at the end of an aisle of the shelf system, wherein the device comprises a retaining element, the retaining element having a flexible element. A shelf system and a shuttle are also provided.

This nonprovisional application is a continuation of International Application No PCT/EP2021/073305, which was filed on Aug. 23, 2021, and which claims priority to German Patent Application No 10 2020 122 390.0, which was filed in Germany on Aug. 27, 2020, and which are both herein incorporated by reference.

### BACKGROUND OF THE INVENTION

### Field of the Invention

The invention relates to a device for securing a shuttle, a shuttle and a shelf system.

### Description of the Background Art

In automated warehouse technology, in particular in the sub-area of small load carriers, the load carriers, which are often designed as boxes, are usually transported by a shuttle in a shelf system, which is therefore also referred to as a warehouse shuttle system. The shelf system comprises several shelves arranged side by side, which in turn usually comprise several levels. Between in each case two shelves, aisles are arranged for at least one shuttle each. The latter transports the load carriers to a shelf bay of the shelf assigned by the logistics system and stores them there or retrieves a load carrier from a shelf bay and transports it to a transfer area. This is usually arranged on an end face of the shelf and has elevators that transport the load carriers to the different levels of the shelves. Of course, the transfer area can also be arranged at a different shelf position. In the transfer area, the load carrier is transferred from the elevators to a transfer station of the shelf, which may be powered and/or not powered. From the transfer station, the load carrier is taken over by the shuttle and subsequently transported by it to the assigned shelf bay. There, the shuttle is positioned with respect to the shelf bay and the load carrier is moved into the shelf bay. The shuttles reach speeds of up to 7 m/s. For safety reasons, each level of a shuttle system must be secured in such a way that a shuttle cannot freely leave the system in case of failure, such as a power failure. So far, this has been achieved via mechanical buffers at the ends of the running rails. These include an elaborate mechanical design, such as switchable flaps and stops. The region of the running rail required for this cannot be used in normal operation and occupies a considerable space in the shuttle system. This has the disadvantage that it cannot be used for shelves, i.e., as a storage space.

### SUMMARY OF THE INVENTION

It is therefore an object of the present invention to provide a device, a shuttle and a shelf system which eliminate the disadvantages of the prior art described above.

A device according to the invention for a shelf system for load carriers for securing a shuttle before leaving its running rail at the end of an aisle of the shelf system comprises a retaining element, which according to the invention in turn comprises a flexible element.

In this context, a retaining element is to be understood as an element which brakes the shuttle in the event of failure in such a way that it remains in contact with the running rail, for example with at least one axle. In particular, the retaining element is intended to ensure that the shuttle cannot fall off the shelf. An event of failure occurs when the shuttle leaves the permitted region of its running rail during operation and/or a control device loses control of the shuttle. Flexible elements, such as ropes, chains or straps, have the advantage that, when loaded on tension, they can absorb large forces and dissipate energy through elastic deformation. Furthermore, the force in the direction of movement of the shuttle can be deflected in a comparatively small space. As a result, further components of the device for absorbing this force and dissipating the kinetic energy of the shuttle can be arranged in a space outside the running rail of the shuttle. Thus, the length of the shelf that cannot be used for storage can be reduced or, in other words, the region of the shelf in which load carriers can be stored can be increased.

In particular, at least in the region of the aisle of the shuttle, the retaining element may be formed as a flexible element.

Furthermore, the retaining element can be aligned in one plane perpendicular to the direction of movement of the shuttle. This can be, for example, an orientation from top to bottom, i.e., in the direction of gravity or parallel to the plane of the running rail and perpendicular to the direction of the movement of the shuttle. Of course, alignments at other angles to gravity and the plane of the running rail are also conceivable.

Furthermore, at least two retaining elements can come into contact with the shuttle in the event of failure. A second retaining element distributes the load on the shuttle, and the risk of a single retaining element deflecting laterally can be advantageously reduced. In addition, the second retaining element may be designed in such a way that it can brake the shuttle redundantly with respect to the first retaining element, whereby safety can be advantageously increased.

Furthermore, the retaining elements can intersect. This can further reduce the risk of lateral deflection of the retaining element formed in the region of the aisles as a flexible element.

The retaining elements may be connected to each other. These can be connected, for example, at the intersection point of two retaining elements. If there are multiple retaining elements, these can be designed as a grid, which offers maximum protection against the shuttle falling. Alternatively, a combination of at least two flexible elements of the retaining element, which are laterally arranged on an aisle and formed as a rope, and a rope or grid tensioned between the ropes is conceivable.

The retaining element may span at least one level of an aisle of the shelf system. Depending on the orientation of the retaining element, it can, for example, span the end of the aisle between two risers, similar to a railing. If the retaining elements are oriented from top to bottom, it makes sense to span several levels of the shelf system.

In particular, the retaining element can span all levels of an aisle of the shelf system. This reduces the necessary number of anchor points of the retaining element, which can have an advantageous effect on the complexity of the shelf system and thus on the manufacturing costs.

Furthermore, the device may comprise an elastic element. The elastic element may, for example, be designed as a tension spring and preload the retaining element. Furthermore, the abrupt load on the retaining element and the flexible element can be mitigated by the elastic element in the event of failure. In addition, during servicing, for example for the replacement of a shuttle, the flexible element can be lengthened across the elastic element, whereby it can simply be pushed aside in the region of an aisle.

In addition, the device may include a damper. This dampens the movement of the retaining element and thus the movement of the shuttle and can at the same time keep the load on the shuttle as low as possible. To extend the path of the damper, the distance travelled on the damper can be increased by means of pulley kinematics as compared to the deflection of the retaining element by the shuttle. The damper can be an elastomer, fluid damper or any other suitable type of damper.

The device may also comprise an active preload unit. This may be formed, for example, as an actuator. In the event of failure, for example, a light barrier or other suitable sensor can be used to detect the shuttle leaving the approved region of the running rail before the shuttle comes into contact with the retaining element. The signal can be transmitted to a control device, which activates the active preload unit. As a result, the tension of the retaining element can be increased as compared to normal operation. The active preload unit can also be integrated into the damper and/or bridge the spring in the event of failure. Furthermore, the retaining element can be guided via guides in the region of the aisles. The guides can be formed as eyelets or hooks and can reduce movement perpendicular to the longitudinal expansion of the retaining element, thereby ensuring that the retaining element is in the correct position at all times. In addition, the guides can be used to move the retaining element in the direction of the shelves in the event of failure, thereby freeing access to the aisle. The guides can be detachable or movable. In particular, the guides may be motor driven, creating access to the aisle controlled via a control device.

The guide may be arranged above and/or below the running rail of the shuttle. By arranging the guides above and below the running rail, the evasive movement of the retaining element in the direction of the movement of the shuttle can be reduced to the length between two guides in the event of failure. The direction of the energy is deflected at the guides, whereby the elastic component and/or the damper of the retaining element can be activated almost immediately after deflection of the retaining element by the shuttle. The distance travelled by the shuttle to a standstill can thus be advantageously reduced.

In addition, the retaining element may have a circumferential configuration.

Furthermore, the retaining element can be guided over deflection rollers. These may be formed in particular such that the retaining element is held securely and a jumping out of the retaining element from the deflection rollers is not possible at any time. The deflection rollers may be arranged, for example, at the upper end of the shelf and at the bottom of the shelf. The alignment of the deflection rollers can be such that the retaining element is deflected in a plane parallel to the end of the shelf. The elastic element and the damper can be arranged in a region next to the running rail, i.e., not in extension of the running rail. This advantageously reduces the required installation space of the shelf in the direction of the aisle.

The retaining element may be connected to an elevator of the shelf system. The retaining element can, for example, be connected to the elevator via an anchor. In this case, one end of the retaining element is connected to the elevator with a first anchor and the other end of the retaining element, for example deflected over deflection rollers, with a second anchor. The anchors may be located on opposite sides of an elevator platform. This arrangement has the advantage that the shuttle can be easily and quickly replaced, for example for maintenance/troubleshooting, without the retaining element interfering.

A shuttle for a device as described may comprise at least one region for receiving at least one retaining element. The region may include a simple depression or recess for the retaining element. This may further be formed, for example, such that the retaining element is clamped on contact. In the event of an imminent fall of the shuttle, it can be held by the clamping of the retaining element. Such a mechanism may, for example, be similar to an emergency brake of a vertical elevator or a clamping of a gondola with the drive cable; the region may be formed in particular as a crumple zone.

A crumple zone has the task of at least partially absorbing the energy of the impact, for example through deformation, and minimizing or preventing damage to the load carriers and in particular to the components installed in the shuttle. The crumple zone may be designed in such a way that it can be easily replaced so that the shuttle can be reused after a functional test. This eliminates the need to maintain additional shuttles in the event of failure. At the very least, the number of additional shuttles can be reduced to a minimum, which can have a positive effect on the manufacturing costs and operating costs of the shelf system.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a level of a warehouse shuttle system in which the invention can be applied;

FIG. 2 is a perspective view from the front on a warehouse shuttle system;

FIG. 3 is a detailed view of the invention; and

FIG. 4 is a further detailed view of the invention.

### DETAILED DESCRIPTION

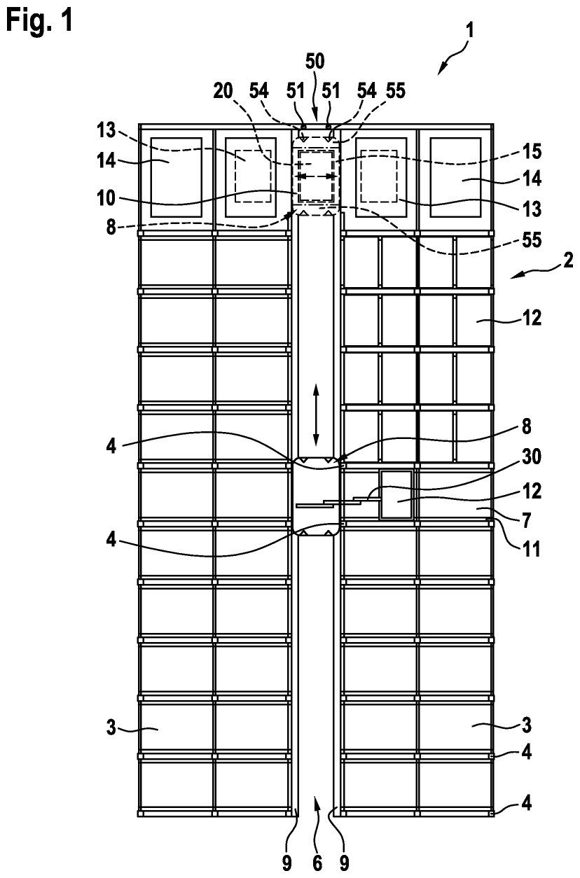

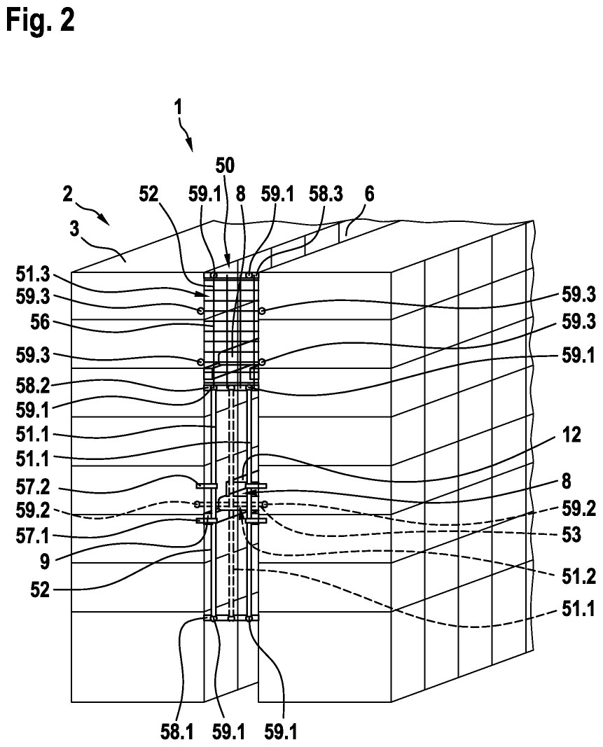

FIG. 1 shows a top view of a section of a level of a storage system for small load carriers (load carriers) designed as a warehouse shuttle system 1, in which two shelves 3 of a shelf system 2 are shown. Small load carriers 12 usually have a footprint of 400×600 millimeters and a maximum weight of 50 kg, with a maximum height of 600 mm. Between the two shelves 3, an aisle 6 with a running rail 9, which is attached to risers 4 of the two adjacent shelves 3, is arranged. In the example shown, a shuttle 8 with a load-receiver 10 transports a load carrier 12 formed as a box along aisle 6. In a transfer region arranged at the end face of the shelves 3, which may be powered or not powered, the load carriers 12 are transferred to a transfer station 13 by elevators 14, which transport the loading carriers 12 to the individual levels of the shelves 3. From the transfer station 13, the load-receiver 10 takes over the load carrier 12 with the help of the displacement unit 20 and transports it to a shelf bay 7 in the shelves 3 provided for storage. The movement of the shuttle 8 in aisle 6 is indicated in the figure with a double arrow. In the example shown, the load-receiver 10 stores the load carrier 12 in one of the four possible positions in the shelf bay 7. The displacement unit 20 comprises for this purpose a lifting device not shown in the figure for raising the load carrier 12 and a horizontal drive designed as a telescopic drive 30. The load-receiver 10 with the lifting device is pushed into the shelf bay 7 by the telescopic drive 30 on support profiles 11, which are arranged on each side of the shelf bay 7 at the risers 4. In this case, the load carrier 12 is raised by the lifting device in such a way that it hovers at a distance of 1 mm to 25 mm above the support profiles 11. At the predetermined position in the shelf bay 7, the load carrier 12 is lowered by the lifting device so that it comes to rest on the support profiles 11. The support profiles 11 are designed in such a way in the above example that they are used both as a running rail for the load-receiver 10 and as a support for the load carrier 12. Alternatively, the running rail for the load-receiver 10 and the support for the load carrier 12 may also be designed as two independent components. At the end of the aisle 6 of the shelf system 2, the device 50 is arranged with two retaining elements 51 which run perpendicular to the aisle 6 and parallel to the end of the shelf system into the plane of FIG. 1. These are, as will be explained in more detail in FIG. 2, fixed at anchor points not shown in FIG. 1 and led over guides, also not shown in FIG. 1, along the shelf system 2 across the individual levels. In the chassis 15 of the shuttle 8 in the example shown, a recess 54 for each of the retaining elements 51 is formed, which can safely accommodate said elements in the event of failure, i.e., when the shuttle 8 leaves the region of the running rails intended for operation. This advantageously minimizes the risk of the retaining elements 51 sliding or slipping on the chassis 15 of the shuttle 8. Furthermore, in the embodiment shown, the front and rear region of the shuttle 8, i.e., the regions which come into contact with the retaining elements 51 in the event of failure, is formed as a crumple zone 55. This dampens the impact energy in addition to the retaining elements 51 and can thereby minimize or prevent additional damage to the functional elements of the shuttle 8.

FIG. 2 shows a perspective view from the front of a warehouse shuttle system 1, in which various embodiments of the retaining element 51 are shown by way of example. In the lower region, in the middle and at the upper end of the shelf system 2, cross bars 58.x are formed, which are fixed to the shelves 3 on both sides of the aisle 6. On these, anchor points 59.x for the retaining elements 51 are arranged. A first embodiment of the invention comprises two retaining elements 51.1, which run parallel to each other at the front of the shelf system 2 across several levels. In the embodiment shown, the retaining element 51.1 comprises, in particular in the region of the running rail 9 and the shuttle 8, a flexible element designed as a rope 52. The retaining elements 51.1 are fixed at the lower 58.1 and the middle cross bar 58.2 at the anchor points 59.1 and are guided in the region of the aisle 6 with the shuttle 8, by way of example by guides 57.1, 57.2. These are arranged on the shelves 3 above and below aisle 6, so that each retaining element 51.1 runs through two guides 57.1, 57.2 in the region of the aisle. Depending on the design, the guides 57.1, 57.2 may be arranged in such a way that an upper guide 57.2 of an aisle 6 simultaneously corresponds to the lower guide 57.1 of the overlying aisle 6. The guides 57.1, 57.2 may be designed as hooks or eyelets or similar. A variant of this embodiment of the retaining element 51.1 is a single retaining element 51.1, which is arranged in the middle between the shelves 3 in front of the aisle 6. This variant is shown dashed in FIG. 2 and is also attached to the anchor points 59.1 on the lower 58.1 and middle cross bar 58.2.

A second embodiment of the retaining element 51.2 is also shown dashed in FIG. 2 and runs perpendicular to the first embodiment of the retaining element 51.1 and parallel to the front of the shelf system 3. The anchor points 59.2 are fixed to the shelves 3, which are arranged to the left and right of the aisle 6. The retaining element 51.2, which is formed predominantly of a flexible element formed as a strap 53, is arranged in the middle, or at the height of the center of gravity, of the shuttle 8 at the end of the shelf system 2 in front of the aisle 6. Due to the strap 53, the contact surface between the retaining element 51.2 and the shuttle 8 is larger than with a rope. The risk of slipping off the shuttle 8 is thus lower, so that one retaining element 51.2 may be sufficient for certain applications.

A third embodiment of the retaining element 51.3 is shown in the upper region of the shelf system 3 in FIG. 2. The retaining element 51.3 comprises a grid 56 made of a plurality of flexible elements, such as ropes 52. This is attached at anchor points 59.1 to the upper 58.3 and the middle cross bar 58.2. The grid 56 may additionally be fixed at further anchor points 59.3 along the levels. The grid 56 has the advantage that load carriers 12 possibly ejected from the shuttle 8 by its abrupt braking are also stopped.

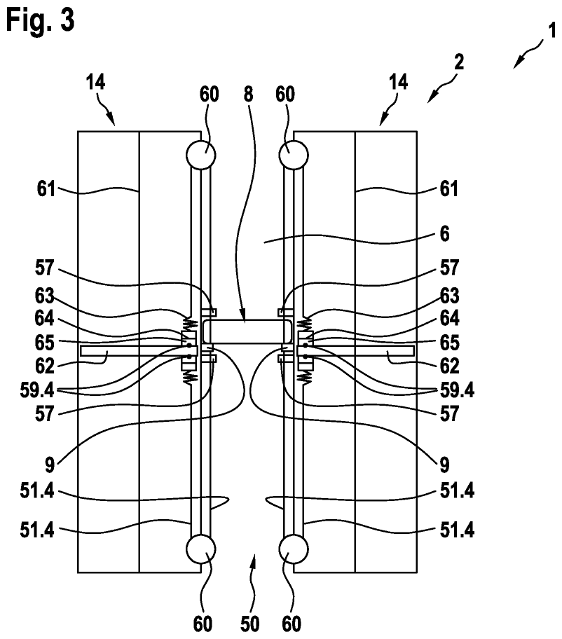

FIG. 3 shows a detailed view of the invention in which a shelf system 2 with two circumferential retaining elements 51.4, which are formed as ropes in the example shown, are displayed. For reasons of clarity, in the example shown, the shelf system 2 is limited to two elevators 14 and an aisle 6 with running rails 9 and a shuttle 8. The ropes 51.4 are, as in the first embodiment of FIG. 2, arranged from top to bottom across several levels of the shelf system 2 and are led by guides 57. In contrast to the embodiment in FIG. 2, the retaining element 51.4 is not held by anchor points 59.1 above and below on the shelf system, but at the top and bottom of the shelves 3, each over a deflection roller 60. The rope 51.4 is attached directly to anchor points 59.4 on the elevator platform 62 of the elevators 14, which are connected via a connection 61 to the drives (not shown) of the elevator 14. Between the elevator platforms 62 and the anchor points 59.4 of the rope 51.4, an elastic element formed as a spring 63, a damper 64 and an active preload unit 65 are arranged. The spring 63, which is designed as a tension spring, can pre-tension the rope 51.4. Furthermore, the spring 63 can mitigate the abrupt load of the rope 51.4, thereby reducing the load to the anchor points 59.4. During servicing, for example if a shuttle 8 is to be taken out of the shelf system 2 for maintenance, the spring 63 advantageously facilitates a pulling apart of the ropes 51.4. The damper 64 dampens the movement of the rope 51.4 in the event of failure and advantageously prevents an abrupt stopping of the rope 51.4, for example at a stop. In the event of failure, the active preload unit 65 can pre-tension the rope 51.4 higher before the shuttle 8 hits the rope. As a result, the movement of the rope 51.4 can be reduced by the shuttle 8 in the direction of travel of the shuttle 8. The active preload unit 65 may be integrated in the damper 64 and/or bridge the spring 63 in the event of failure to achieve an even stiffer connection between rope 51.4 and damper 64.

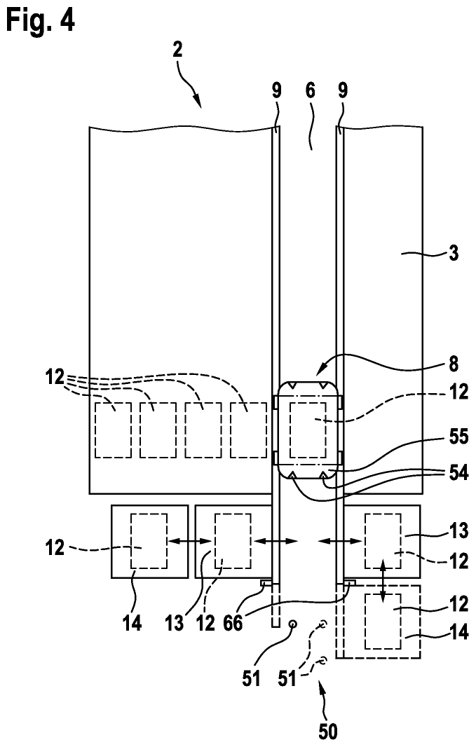

FIG. 4 shows a further detailed view of the invention in which the end of a shelf system 2 of a warehouse shuttle system 1 is shown in a top view. The running rail 9 of the shuttle 8 is represented in FIG. 4 by a solid line up to the transfer stations 13 at the end of the shelves 3. This represents the region of the running rail 9 used by the shuttle 8 during operation. The continuation of the running rail 9 is shown dashed in FIG. 4, wherein the left and the right side represent two different embodiments. This region is only used by the shuttle 8 in the event of failure or if the shuttle 8 is to be retrieved from the shelf system 2 for maintenance purposes. At the interface of the two regions, a light barrier 66 is arranged, which can detect if the shuttle 8 exits the region used in operation. The signal can be sent to a control device (not shown), which may, for example, trigger the active preload unit 65. The left side of FIG. 4 shows a first embodiment in which the elevator 14 is arranged in a plane parallel to the front of the shelf system 2 next to the transfer station 13. This is particularly advantageous if the shelf 3 is designed such that it can accommodate at least 2,3,4,5 or 6 load carriers 12 consecutively. By the lateral arrangement of the elevator 14, the length of shelf 3 is reduced or more space for load carriers 12 is created at a given length of the warehouse shuttle system 1. The load carriers 12 are transported according to the double arrows from the elevator 14 via the transfer station 13 to the shuttle 8. The running rail 9 may be formed shorter due to the inventive device 50 with the retaining element 51, which is arranged across several levels along the front of the shelf system 2, thus saving further installation space. The right side of FIG. 4 shows a second embodiment in which the elevator 14 is arranged in extension of the shelf 3 in front of the transfer station 13. Here, too, the double arrows shown in FIG. 4 indicate the movement of the load carriers 12 from the elevator 14 via the transfer station 13 to the shuttle 8. The running rail 9 can be continued in this case without disadvantages with regard to the installation space to the front end of the elevator 14. As a result, the retaining element 51 can be arranged either, as on the left side at the end of the running rail 9 or further in the direction of the shelves 3, which is represented by a dashed retaining element 51 in FIG. 4. This has the advantage that the braking distance of the shuttle 8 can be extended and thus the load on the shuttle 8 can be advantageously reduced, thereby reducing the risk of damage to the shuttle 8. The shuttle 8 comprises, as already described in FIG. 1, recesses 54 for the retaining element 51 and a crumple zone 55.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for a shelf system for load carriers for securing a shuttle before leaving its running rail at an end of an aisle of the shelf system, the device comprising a retaining element that comprises a flexible element.

2. The device according to claim 1, wherein the retaining element is formed as a flexible element, at least in the region of the aisle of the shuttle.

3. The device according to claim 1, wherein the retaining element is aligned in a plane substantially perpendicular to the direction of movement of the shuttle.

4. The device according to claim 1, wherein at least two retaining elements come into contact with the shuttle in the event of failure.

5. The device according to claim 4, wherein the retaining elements intersect.

6. The device according to claim 4, wherein the retaining elements are connected to each other.

7. The device according to claim 1, wherein the retaining element spans at least one level of an aisle of the shelf system.

8. The device according to claim 1, wherein the retaining element spans all levels of an aisle of the shelf system.

9. The device according to claim 1, wherein the device comprises an elastic element.

10. The device according to claim 1, wherein the device comprises a damper.

11. The device according to claim 1, wherein the device comprises an active preload unit (65).

12. The device according to claim 1, wherein the retaining element is led via guides in a region of the aisles.

13. The device according to claim 12, wherein the guide is arranged above and/or below the running rail of the shuttle.

14. The device according to claim 1, wherein the retaining element is circumferential.

15. The device according to claim 1, wherein the retaining element is guided over deflection rollers.

16. The device according to claim 1, wherein the retaining element is connected to an elevator of the shelf system.

17. A shelf system comprising a device according to claim 1.

18. A shuttle for a device according to claim 1, wherein the shuttle comprises at least one region for receiving at least one retaining element.

19. The shuttle according to claim 18, wherein the region is formed as a crumple zone.
